(19) United States
(12) Patent Application Publication
(10) Pub. No.: US 2014/0092788 A1
(43) Pub. Date: Apr. 3, 2014

(54) METHOD AND APPARATUS FOR TRANSMITTING AND RECEIVING DATA IN MOBILE COMMUNICATION SYSTEM

(71) Applicant: Samsung Electronics Co. Ltd., Suwon-si (KR)

(72) Inventors: Hyoung-Ju JI, Seoul (KR); Joon-Young CHO, Suwon-si (KR); Young-Bum KIM, Seoul (KR); Seung-Hoon CHOI, Suwon-si (KR)

(73) Assignee: Samsung Electronics Co. Ltd., Suwon-si (KR)

(21) Appl. No.: 14/039,381

(22) Filed: Sep. 27, 2013

(30) Foreign Application Priority Data
Sep. 28, 2012 (KR) 10-2012-0109157

(51) Int. Cl. H04W 72/04

(52) U.S. Cl. CPC H04W 72/0446
USPC 370/280

(57) ABSTRACT

A data transceiving method of a terminal in a mobile communication system is provided. The data transceiving method includes receiving a Time Division Duplex (TDD) configuration modification message including TDD configuration modification time information from a base station, modifying a TDD configuration based on the TDD configuration modification time information, transmitting, to the base station, at least one of a data channel and a response channel by taking into consideration a transmission period between the data channel and the response channel. and the transmission period is determined for mapping first subframes for transmitting at least one of a data channel and a response channel before the TDD configuration modification, onto second subframes for transmitting at least one of a data channel and a response channel after the TDD configuration modification.

### CROSS-REFERENCE TO RELATED APPLICATION(S)

This application claims the benefit under 35 U.S.C. §119(a) of a Korean patent application filed on Sep. 28, 2012 in the Korean Intellectual Property Office and assigned Serial No. 10-2012-0109157, the entire disclosure of which is hereby incorporated by reference.

### TECHNICAL FIELD

The present disclosure relates to a method and apparatus for transmitting and receiving data in a mobile communication system. More particularly, the present disclosure relates to a method and apparatus for transmitting and receiving data between a base station and a terminal, which seamlessly continues a Hybrid Automatic Repeat reQuest (HARQ) in a downlink and an uplink in a system in which an amount of resource of an uplink and an downlink dynamically varies over time, in spite of the dynamic variance of the system.

### BACKGROUND

Mobile communication systems have generally been developed in order to provide a user with both mobility and communication. Mobile communication systems have now reached a stage where it is possible to provide a high-speed data communication service in addition to voice communication.

Recently, standardization for a Lone Term Evolution (LTE) system, which is one of the next generation mobile communication systems, has been conducted by the 3^{rd} Generation Partnership Project (3GPP). The LTE system is a technology that embodies a high speed packet-based communication having a transmission rate of up to 100 Mbps, which is higher than a data transmission rate that is currently provided, and the standardization has almost been completed. As the LTE standard has been completed, an advanced LTE system (LTE-Advanced: LTE-A) that improves a transmission rate by combining various state-of-the-art technologies with the LTE communication system has been actively discussed. Hereinafter, the LTE system is defined to include the LTE system and the LTE-A system.

A Time Division Duplex (TDD) system according to the related art divides a single frequency band into a downlink and an uplink based on a time. In the TDD system, a data channel, a control channel, and a response channel may need to be organically operated so as to support a Hybrid Automatic Repeat reQuest (HARQ) in a downlink and an uplink. A configuration of each link should be determined in advance to prevent interference between links (an uplink and a downlink) due to a neighboring cell, and all of the cells use the configuration simultaneously so that a method of transmitting channels for supporting a HARQ in a downlink and an uplink may be used based on a corresponding configuration.

In a dynamic TDD system, which is an advanced TDD system, a configuration of a link may be different for each cell. The configuration may be a time varying configuration. Accordingly, when a configuration of a system is modified in a cell and a HARQ transmission method is modified, HARQ retransmission before and after the modification of the system configuration may not be maintained. Therefore, performance of the dynamic TDD system may be decreased.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for transmitting and receiving data in a mobile communication system.

Another aspect of the present disclosure is to provide a method and apparatus for maintaining a Hybrid Automatic Repeat reQuest (HARQ) process, and simultaneously, for maximally utilizing resources of uplink and downlink data channels of a modified TDD system.

In accordance with an aspect of the present disclosure, a data transceiving method of a terminal in a mobile communication system is provided. The data transceiving method includes receiving a Time Division Duplex (TDD) configuration modification message including TDD configuration modification time information from a base station, modifying a TDD configuration based on the TDD configuration modification time information, and transmitting, to the base station, at least one of a data channel and a response channel by taking into consideration a transmission period between the data channel and the response channel, wherein the transmission period is determined for mapping first subframes for transmitting at least one of a data channel and a response channel before the TDD configuration modification, onto second subframes for transmitting at least one of a data channel and a response channel after the TDD configuration modification.

In accordance with another aspect of the present disclosure, a data transceiving method of a base station in a mobile communication system is provided. The data transceiving method includes transmitting, to a terminal, a TDD configuration modification message including TDD configuration modification time information, modifying a TDD configuration based on the TDD configuration modification time information, and receiving, from the terminal, at least one of a data channel and a response channel by taking into consideration a reception period between the data channel and the response channel, wherein the reception period is a period determined for mapping first subframes for receiving one of a data channel and a response channel before the TDD configuration modification onto second subframes for receiving one of a data channel and a respond channel after the TDD configuration modification.

In accordance with another aspect of the present disclosure, a terminal in a mobile communication system is provided. The terminal includes a receiving unit configured to receive, from a base station, a TDD configuration modification message including TDD configuration modification time information, a controller configured to modify a TDD configuration based on the TDD configuration modification time information, and a transmitting unit configured to transmit, to the base station, at least one of a data channel and a response channel by taking into consideration a transmission period between the data channel and the response channel, wherein the transmission period is a period determined for mapping first subframes for transmitting one of a data channel and a response channel before TDD configuration modification onto second subframes for transmitting one of a data channel and a response channel after the TDD configuration modification.

In accordance with another aspect of the present disclosure, a base station in a mobile communication system is provided. The base station includes a transmitting unit configured to transmit, to a terminal, a TDD configuration modification message including TDD configuration modification time information, a controller configured to modify a TDD configuration based on the TDD configuration modification time information, and a receiving unit configured to receive, from the terminal, at least one of a data channel and a response channel by taking into consideration a reception period between the data channel and the response channel, wherein the reception period is a period determined for mapping first subframes for receiving at least one of a data channel and a response channel before TDD configuration modification onto second subframes for receiving at least one of a data channel and a response channel after the TDD configuration modification.

According to an embodiment of the present disclosure, while a base station dynamically modifies TDD configuration information, time-varying allocation of uplink and downlink resources is continuously performed in a cell, irrespective of whether retransmission generated from downlinks and uplinks of scheduling terminals exists. Also, a Hybrid Automatic Repeat reQuest (HARQ) process is maintained, and simultaneously, resources of uplink and downlink data channels of a modified TDD system may be maximally used.

According to an embodiment of the present disclosure, when control channel transmission resources for retransmission and initial transmission do not exist, a radioframe configuration modification operating method inserts a TDD configuration that secures control channel transmission between a previous radioframe and a modified radioframe so as to seamlessly operate all HARQs.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a downlink subframe and an uplink subframe used in a mobile communication system according to an embodiment of the present disclosure;

FIG. 2 illustrates a retransmission process of a data channel in a mobile communication system according to an embodiment of the present disclosure;

FIG. 3 illustrates an operation of a dynamic TDD system according to an embodiment of the present disclosure;

FIG. 4 illustrates a timing problem occurring in an uplink HARQ process due to modification of TDD configuration information according to an embodiment of the present disclosure;

FIG. 5 illustrates a timing problem occurring in a downlink HARQ process due to modification of TDD configuration information according to an embodiment of the present disclosure;

FIG. 6 illustrates an uplink HARQ process according to a first embodiment of the present disclosure;

FIG. 7 illustrates an uplink HARQ process according to a second embodiment of the present disclosure;

FIG. 8 illustrates a downlink HARQ process according to a third embodiment of the present disclosure;

FIG. 9 illustrates a HARQ process according to a fourth embodiment of the present disclosure;

FIG. 10 illustrates a HARQ process according to a fifth embodiment of the present disclosure;

FIG. 11 is a flowchart of an operation of a base station according to an embodiment of the present disclosure;

FIG. 12 is a flowchart of an operation of a terminal according to an embodiment of the present disclosure;

FIG. 13 is a flowchart of an operation of a terminal according to an embodiment of the present disclosure;

FIG. 14 is a block diagram of an internal configuration of a base station according to an embodiment of the present disclosure; and

FIG. 15 is a block diagram of an internal configuration of a terminal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure relates to a communication system in which a base station transmits a downlink signal to a terminal, and a terminal transmits an uplink signal to a base station. The downlink signal may include a data channel including a data signal transmitted to a terminal, a control channel that transmits a control signal, and a Reference Signal (RS) for channel estimation and channel feedback. A base station transmits, to a terminal, a data channel and a control channel through a Physical Downlink Shared Channel (PDSCH) and a Downlink Control Channel (DLCCH), respectively. The uplink signal includes a data channel that a terminal transmits, a control channel, and an RS. The data channel is transmitted through a Physical Uplink Shared Channel (PUSCH), and the control channel is transmitted through a Physical Uplink Control Channel (PUCCH).

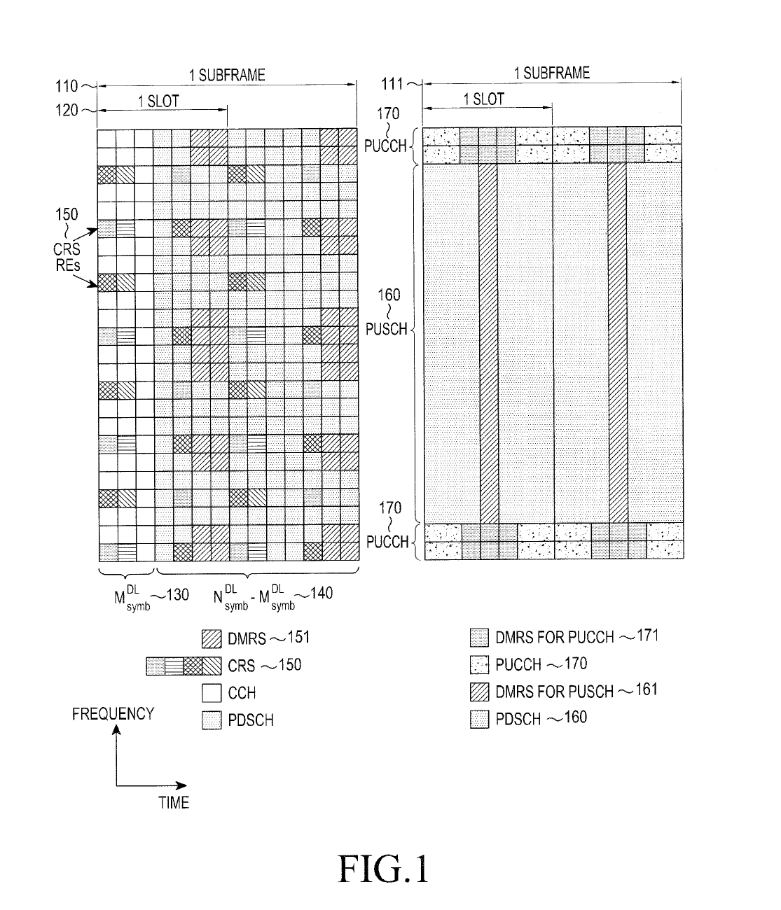

A base station may have a plurality of RSs. The plurality of RSs include a Common Reference Signal (CRA), a Channel State Information RS (CSI-RS), and a Demodulation Reference Signal (DMRS) or a terminal-dedicated RS. The CRS is transmitted over the whole bandwidth of a downlink, and all of the terminals in a cell use the CRS for demodulating a signal and performing channel estimation. The base station transmits a DMRS to only a scheduled area of a terminal so as to reduce resources used for transmitting a CRS, and transmits a CSI-RS in time and frequency axes to obtain channel information, which will be described in detail with reference to FIG. 1.

FIG. 1 illustrates a downlink subframe and an uplink subframe used in a mobile communication system according to an embodiment of the present disclosure.

Referring to FIG. 1, a scheduling unit of a base station is a downlink subframe 110. A single downlink subframe 110 includes two slots 120, is formed of a total of N_{symb}^{DL} symbols, and transmits a control channel, a data channel, and a reference signal. M_{symb}^{DL} symbols which are located chronologically earlier are used for transmitting a control channel 130, and the remaining symbols (i.e., N_{symb}^{DL}−M_{symb}^{DL} symbols), are used for transmitting a data channel 140. A transmission bandwidth is formed of Resource Blocks (RBs) in a frequency. Each RB is formed of a total of N_{sc}^{RB} subcarriers or Resource Elements (REs). A unit of two slots in a time axis and a single RB is referred to as a PRB pair. A CRS 150, a CSR-RS, and a DMRS 151 are transmitted through a single PRB pair.

The uplink subframe 111 is divided into two slots. An uplink control channel 170 is distinguished from the data channel 160 based on a frequency axis, unlike the downlink control channel which is distinguished based on a time axis. The uplink data channel 160 and the control channel 170 are transmitted through corresponding DMRSs 161 and 171, respectively.

Table 1 illustrates a radioframe configuration in a TDD system. The radioframe has a total of 7 configurations. In the case of a single radioframe that is formed of 10 subframes, a transmission direction of each subframe is determined as shown in Table 1. In Table 1, ‘D’ denotes downlink transmission, ‘U’ denotes uplink transmission, and ‘S’ denotes a special subframe in which a few symbols are used as a downlink and the remaining symbols are used for uplink transmission. Typically, the special subframe is for securing a link transition time between a downlink and an uplink, and is capable of transmitting a control channel and a data channel in a downlink but is incapable of transmitting a control channel and a data channel in an uplink. However, the special subframe is capable of transmitting a reference signal for uplink channel estimation.

TABLE 1

| TDD system | transmission direction of subframe | | | | | | | | | |
|---|---|---|---|---|---|---|---|---|---|---|
| configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

Dedicated Control Information (DCI) is transmitted to a terminal for various purposes. For example, a DCI may be used for scheduling a downlink data channel or an uplink data channel, a DCI may be transmitted for transferring system information, for initial access, or paging, and a DCI may be transmitted for controlling power of a terminal.

The DCI includes a Cyclic Redundancy Check (CRS) bit, so as to enable a terminal to determine a DCI transmitted to the terminal. The DCI scrambles a Radio Network Temporary Identifier (RNTI) and transmits the scrambled RNTI to a CRC. A base station allocates, to a terminal, a Cell RNTI (C-RNTI) as an RNTI for scheduling, and scrambles the C-RNTI and transmits the scrambled C-RNTI to a CRC of the DCI. RNTI may be used for transmitting system information, for initial access, and/or for paging, among other purposes.

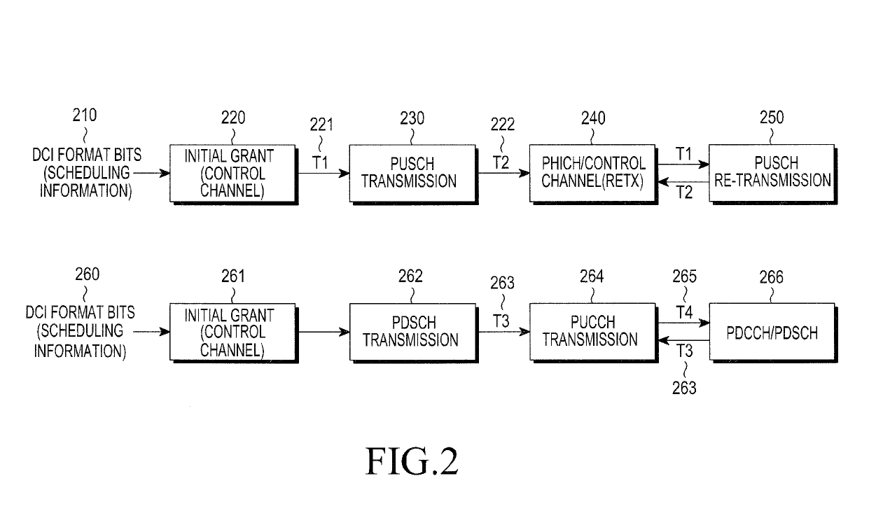

FIG. 2 illustrates a retransmission process of a data channel in a mobile communication system according to an embodiment of the present disclosure. Particularly, FIG. 2 illustrates a control channel and a data channel in a downlink and an uplink, and a retransmission process.

Referring to FIG. 2, a serial data channel transmission process may correspond to a Hybrid Automatic Repeat reQuest (HARQ) process.

To initialize an uplink HARQ process, a base station includes DCI information 210 associated with initial data transmission in a Control Channel (CCH) 220. The base station transfers to a terminal scheduling information associated with uplink transmission. The terminal transmits an uplink data channel (i.e., a PUSCH) 230 after a time t1 221. The time t1 221 is a time determined by taking into consideration a time that the terminal requires to receive scheduling information, to generate a data channel, and to transmit the generated data channel. The base station that receives the data channel from the terminal transmits a response (ACK/NACK) in response to the data channel transmitted from the terminal to a Physical HARQ Indicator Channel (PHICH) after a time t2 222, and configures a DCI 240 for retransmission when the retransmission is required. The time t2 222 is a time determined by taking into consideration a time that the base station requires to receive the data channel, and to generate the response signal. When retransmission is necessary, retransmission data channel transmission and control channel transmission for retransmission 250 are continuously repeated as illustrated in FIG. 2.

The time t1 221 and the time t2 222 may be defined differently based on a radioframe configuration in Table 1, since a location of an uplink subframe of each radioframe is different from one another. Table 2 shows the t1 based on a TDD configuration. Referring to Table 2, a data channel associated with a control channel that is received in an n^{th} subframe from a subframe n in which the control channel is transmitted, is transmitted at n+t1. Table 3 illustrates the time t2 based on a TDD configuration. Referring to Table 3, an uplink data channel is transmitted at i−t2 from a subframe i in which a PHICH or a retransmission control channel is transmitted.

TABLE 2

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

TABLE 3

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

A total number of uplink HARQ processes of each TDD configuration is illustrated in Table 4, based on a definition of time relationship of an uplink HARQ for each TDD configuration.

TABLE 4

| | Number of HARQ processes for |
|---|---|
| TDD UL/DL configuration | normal HARQ operation |
| 0 | 7 |
| 1 | 4 |
| 2 | 2 |
| 3 | 3 |
| 4 | 2 |
| 5 | 1 |
| 6 | 6 |

As illustrated in FIG. 2, to initialize a downlink HARQ process, the base station includes DCI information 260 associated with initial data transmission in a CCH 261, and transfers scheduling information associated with downlink transmission to the terminal. The terminal receives the CCH 261 and receives a downlink data channel 262 in an identical subframe. The terminal that receives the PDSCH 262 from the base station transmits a response (ACK/NACK) in response to the received data channel to a Physical Uplink Control Channel (PUCCH) 264 after a time t3 263, and the base station that receives the response generates a DCI 266 for retransmission when retransmission is necessary and transmits the DCI 266 together with a retransmission data channel to the terminal after a time t4 265. The time t3 263 is a time determined by taking into consideration a time that the terminal requires to receive the data channel from the base station and to generate a response channel. When retransmission is required, retransmission data channel transmission and control channel transmission for retransmission are continuously repeated as illustrated in FIG. 2.

The time t3 263 may be defined differently based on a radioframe configuration in Table 1, since a location of an uplink subframe of each radioframe that may transmit a response channel (PUCCH) is different from one another. Table 5 illustrates a main information field included in a DCI for scheduling an uplink data channel in a TDD system, and in particular illustrates the time t3. Referring to Table 5, an uplink response channel that is transmitted in an n^{th} subframe from a subframe n in which a control channel is transmitted, is a response channel with respect to a data channel that is received in an n-t3^{th} subframe.

TABLE 5

| UL-DL | | | | | | | | | | |
|---|---|---|---|---|---|---|---|---|---|---|
| Config- | Subframe n | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, | — | — | — | — | 8, 7, | — | — |
| | | | 4, 6 | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, | | | | | | | |
| | | | 4, 11, 6 | | | | | | | |
| 6 | — | — | 7 | 7 | 5 | — | — | 7 | 7 | — |

One difference between an uplink HARQ process and a downlink HARQ process is that the uplink HARQ is formed of synchronous transmission and a transmission time of a retransmission data channel is linked with a HARQ process index, and the downlink HARQ is formed of asynchronous transmission and a transmission time of a retransmission data channel is freely generated by a base station after a predetermined time in an available subframe. The content included in uplink and downlink control channel information fields reflect this difference.

Table 6 illustrates an example of a control information field of an uplink data channel, and Table 7 illustrates an example of a control information field of a downlink data channel.

TABLE 6

| Type | Information | Size |
|---|---|---|
| CIF | Carrier indication field | 3 |
| RA | Resource allocation field | Variable |
| MCS | MCS index | 5 |
| NDI | New data indication | 1 |
| TPC | Power command | 2 |
| CS | Cyclic shift | 3 |

TABLE 7

| Type | Information | Size |
|---|---|---|
| CIF | Carrier indication field | 3 |
| RA | Resource allocation field | Variable |
| MCS | MCS index | 5 |
| NDI | New data indication | 1 |
| TPC | Power command | 2 |
| CS | Cyclic shift | 3 |
| RV | Redundancy Version | 2 |
| HARQ | HARQ process number | 4 |

In Table 6 and Table 7, a Modulation and Coding Scheme (MCS) field is for determining a coding rate of an uplink data channel. In the case of an uplink, the coding rate and a Redundancy Version (RV) for retransmission of a HARQ process are joint-coded, unlike a downlink. Accordingly, when the base station transmits to the terminal another RV for previous transmission, a coding rate identical to a previous coding rate should be used. The coding rate is formed of a modulation order and a transport block size index. The modulation order indicates QPSK, 16QAM, and 64QAM, and the TBS index is used for determining an amount of information transmitted per PRB.

In a case of a downlink, a field that uses a coding rate and a field that transmits an RV are formed differently. One difference between downlink DCI information and uplink DCI information is that the uplink does not transmit HARQ process information. In the case of the downlink, HARQ process information is included in the DCI information, since the downlink HARQ process uses an asynchronous method and the uplink uses a synchronous method. The asynchronous method refers to a method in which a time of initial transmission and a time of retransmission are not determined in advance but are determined by a scheduler, and the synchronous method refers to a method in which a time of initial transmission and a time of retransmission are determined in advance. Accordingly, in a TDD system in which initial transmission and retransmission are determined to be performed at different times with respect to all HARQs, a HARQ process is automatically distinguished based on a subframe in which the initial transmission begins.

In a typical TDD system, a radioframe configuration as illustrated in Table 1 may not be changed at all or may not change significantly over time. One flaw of the TDD system is that performance of a system deteriorates due to a predetermined amount of resource of a radioframe when an amount of data in a downlink and an uplink changes. To address this issue, it is desired to dynamically modify the radioframe configured as illustrated in Table 1 to satisfy an amount of data required in a downlink and an uplink based on a predetermined period (for example, for each 10 msec). A system that performs the modification is referred to as a dynamic TDD system.

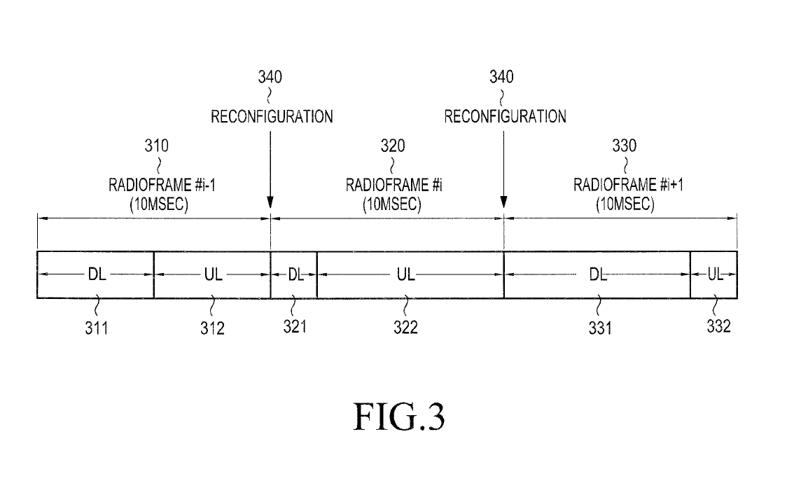

FIG. 3 illustrates an operation of a dynamic TDD system according to an embodiment of the present disclosure.

FIG. 3 illustrates an i−1^{th} radioframe 310, an i^{th} radioframe 320, and i+1^{th} radioframe 330, which are chronologically arranged. In the dynamic TDD system, a control channel (reconfiguration) 340 that modifies a radioframe configuration may be transmitted from a base station. Accordingly, a downlink resource 311 has a similar configuration as an uplink resource 312 in the i−1^{th} radioframe 310, and a downlink resource 321 becomes smaller than an uplink resource 322 in the i^{th} radioframe 320. Similarly, a downlink resource 331 may become larger than an uplink resource 332 in the i+1^{th} radioframe 330. As a result, a number of uplink HARQs may be changed in proportion to the modified uplink resource.

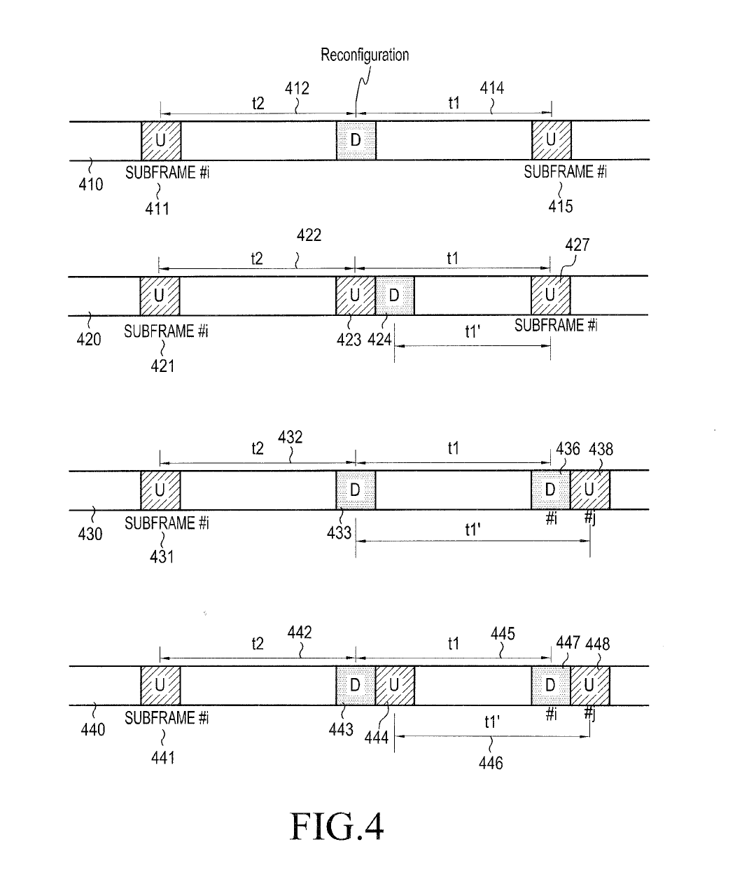

In a case of the dynamic TDD system, when the TDD configuration is continuously modified, a total of possible HARQ processes may be decreased or increased. When the number of HARQ processes does not change, it is considered that an uplink HARQ process of a previous radioframe succeeds and retransmission is not required, or timing relationships of four cases of FIG. 4 may be considered, irrespective of a need for retransmission.

FIG. 4 illustrates a timing problem occurring in an uplink HARQ process as TDD configuration information is modified according to an embodiment of the present disclosure. FIG. 4 illustrates a problem that occurs when a HARQ process is maintained after the TDD configuration information is modified, based on a time axis.

Referring to FIG. 4, the diagram 410 shows a timing relationship of an uplink HARQ in a normal case. When an uplink data channel transmitted in a subframe i 411 of a previous radioframe requests retransmission and a location where a response channel for the request and a retransmission control channel are to be transmitted is generated after a time t2 412, and when a control channel transmission time of an uplink 415 having an identical HARQ process location in an uplink subframe generated after the modification of configuration information is a time t1 414 before the data channel transmission, the HARQ process in which the retransmission time is identical to previous transmission may be maintained as shown in the diagram 410.

In the diagram 420, an uplink data channel transmitted in a subframe i 421 of a previous radioframe requests retransmission, and a location where a response channel for the request and a retransmission control channel are to be transmitted is generated after a time t2 422 (i.e., in uplink 423). This may be a case in which the corresponding subframe is modified into an uplink subframe 423 by the modification of the TDD configuration information. In this case, a control channel transmission location for transmission of a subframe i 427 corresponding to a HARQ process that is identical to a previous HARQ process may exist in a location of the downlink 424 that is different from the uplink 423. Accordingly, the terminal may not maintain the HARQ process of a previous radioframe after the modification of the TDD configuration information.

In the case of the diagram 430, an uplink data channel transmitted in a subframe i 431 of a previous radioframe requests retransmission, and a location where a response channel for the request and a retransmission control channel are to be transmitted is generated after a time t2 432 (i.e., in the diagram 433). This may be a case in which an uplink subframe 436 for maintaining the corresponding HARQ process in a subsequent radioframe is changed into a downlink. In this case, although a HARQ process resource that may be maintained exists in another uplink subframe 438, the HARQ process is not maintained since locations of the HARQ processes are different.

In the case of the diagram 440, an uplink data channel transmitted in a subframe i 441 of a previous radioframe requests retransmission, and a location where a response channel for the request and a retransmission control channel are to be transmitted is generated after a time t2 442 (i.e., in the diagram 443). This may be a case in which a subframe i that needs to maintain the corresponding HARQ process in a subsequent radioframe is changed into a downlink 447. In this case, although a HARQ process resource that may be maintained exists in another uplink subframe 448, a downlink subframe that exists before a time t1′ 446 for transmitting a control channel (i.e., a resource of a subframe 444), is used as an uplink since it is before modification of the TDD configuration. In this case, retransmission may not be performed after the modification of the TDD configuration and a new uplink HARQ may not be performed.

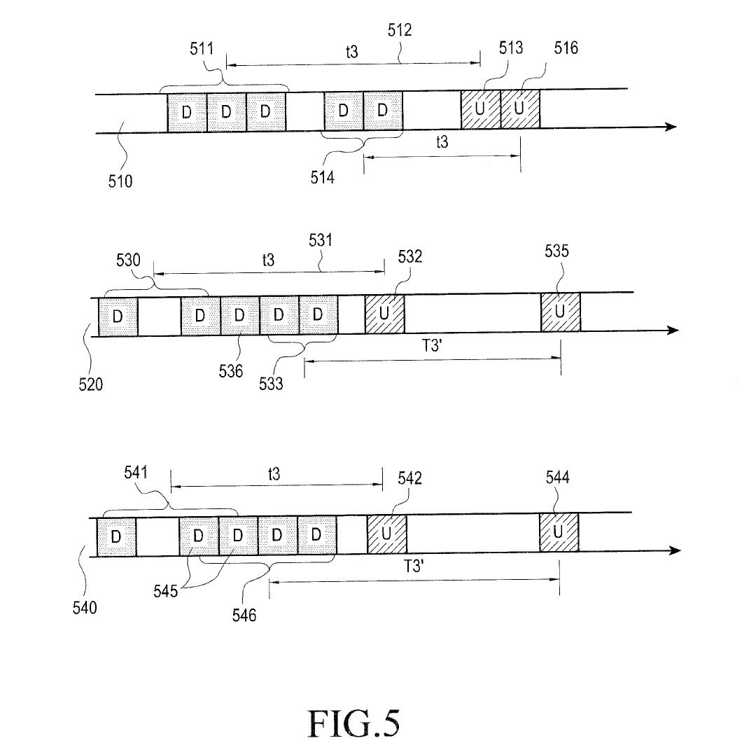

FIG. 5 illustrates a timing problem occurring in a downlink HARQ process due to modification of TDD configuration information according to an embodiment of the present disclosure.

Referring to FIG. 5, the diagram 510 illustrates that downlink subframes 511 and 514 that exist before the TDD configuration are linked with uplink subframes 513 and 516 that exist after TDD configuration, so as to transmit a response channel. The downlink subframe of the diagram 511 transmits a response channel in the uplink subframe of the diagram 513 after a time t3 512.

The diagram 520 corresponds to a case in which response channels transmitted to uplink subframes 532 and 535 existing after modification of the TDD configuration are linked with downlink subframes 530 and 533. In this example, there occurs a case in which a few downlink subframes, for example, the downlink subframe 536, are not linked with an uplink that is provided after TDD configuration. The problem also occurs when an uplink subframe 532 is provided before TDD configuration modification and an uplink subframe of the diagram 535 is provided after TDD configuration modification.

The diagram 540 corresponds to a case in which an uplink subframe 542 is provided before TDD configuration modification, and an uplink subframe 544 is provided after TDD configuration modification. In this case, a downlink linked with the uplink subframe 542 corresponds to the downlink subframes 541 and a downlink linked with an uplink of the diagram 544 corresponds to the downlink subframes 546. This is because a link relationship before and after TDD configuration is different. In this case, there is a problem in that a response channel with respect to a downlink subframe of the diagram 545 is transmitted twice.

As described above, a dynamic TDD system should define a complex timing relationship to continuously execute a HARQ process in an uplink and a downlink. To address this issue, an embodiment of the present disclosure proposes an operation method that defines a single timing irrespective of TDD configuration modification, a previous configuration, and a modified configuration, so as to readily continue a HARQ in spite of the TDD configuration modification.

In an uplink HARQ retransmission method proposed in a first embodiment of the present disclosure, a terminal uses a predetermined rule for a timing of uplink data transmission and response channel transmission and a timing of response channel and uplink data channel retransmission, irrespective of a TDD configuration of a previous radioframe and a TDD configuration of a modified radioframe when a TDD configuration modification command is provided. The predetermined rule indicates a timing configuration method that secures a time of 20 msec between retransmission, and includes a method that sequentially links six successive subframes from a subframe #6 with locations or indices of possible uplink HARQ retransmission that may occur in a modified radioframe. The HARQ link method according to the first embodiment of the present disclosure is a method that uses a time t1 defined in Table 8 and a time t2 defined in Table 9, as described above.

TABLE 8

| TDD UL/DL | subframe number n | | | | | | | | | |
|---|---|---|---|---|---|---|---|---|---|---|
| Configuration | 5 | 6 | 7 | 8 | 9 | 0 | 1 | 2 | 3 | 4 |
| Any | | 6 | 6 | 6 | 8 | 8 | 8 | | | |

TABLE 9

| TDD UL/DL | subframe number i | | | | | | | | | |
|---|---|---|---|---|---|---|---|---|---|---|
| Configuration | 5 | 6 | 7 | 8 | 9 | 0 | 1 | 2 | 3 | 4 |
| Any | | 14 | 14 | 14 | 12 | 12 | 12 | | | |

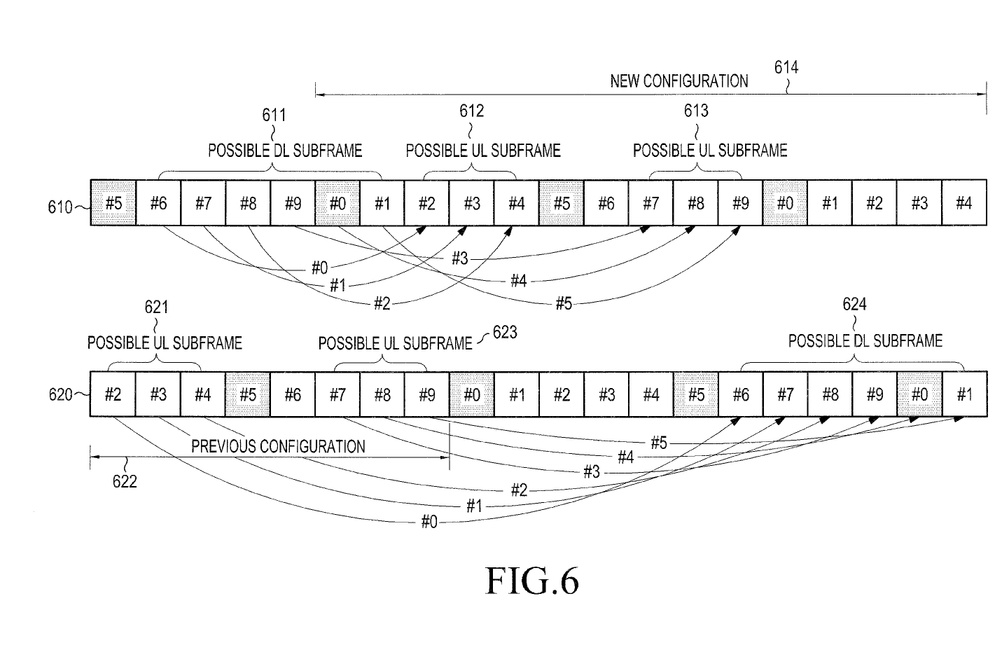

In the first embodiment of the present disclosure, a TDD configuration modification command needs to be received before at least a subframe #5, and a proposed timing needs to be applied before at least a next subframe #5 from the subframe #5, which will be described in detail with reference to FIG. 6.

FIG. 6 illustrates an uplink HARQ process according to a first embodiment of the present disclosure.

Referring to FIG. 6, the diagram 610 illustrates a timing of control channel transmission and uplink data channel transmission, and the diagram 620 illustrates uplink data channel transmission and downlink response channel transmission. In the diagram 610, a TDD configuration modification command should be received previously, and the modification is actually applied in a radioframe of the diagram 614.

A terminal that receives the TDD configuration modification command receives a retransmission control channel or an initial transmission control channel for using an uplink HARQ after the TDD configuration modification, in a downlink subframes 611. The downlink subframes 611 includes a total of 6 successive downlinks, and the downlinks are sequentially linked with 6 possible uplink subframes 612 and 613 that may exist in a subsequent radioframe. Accordingly, irrespective of any TDD configuration that the TDD configuration is modified into based on the TDD configuration modification command, a control channel reception time of a possible uplink subframe is determined based on a previous radioframe.

A time t1 and a time t2 for transmission of a response channel and a control channel that are generated after transmission of a data channel that begins in the uplink subframes 612, are based on a time defined in the configured TDD. When the TDD configuration modification command is received in a state in which an uplink data channel that is transmitted in a previous radioframe exists, a response channel transmission time with respect to the previous data channel transmission is defined as shown in the diagram 620. According to the first embodiment of the present disclosure, response channel transmission times or retransmission control channel transmission times with respect to possible uplink subframes in a previous radioframe, for example, the uplink subframes 621 and the uplink subframes 623, are sequentially mapped to 6 successive downlink subframes in a subsequent radioframe, for example, the downlink subframes 624. According to the configuration as described above, the terminal is capable of transmitting response channels or control channels with respect to all HARQ processes, irrespective of a number of uplinks HARQ processes that previously exist or whether retransmission exists.

When the described HARQ processes are simultaneously used, it is configured that the diagram 620 chronologically comes first, followed by the diagram 610, and that the downlink subframes 624 is identical to the downlink subframes 611. Therefore, when a TDD configuration modification command is generated between the uplink subframes 623 and the downlink subframes 624 while a previous TDD configuration 622 is used, the terminal receives a response channel with respect to a previous uplink HARQ in the uplink subframes 624 (the downlink subframes 611), modifies the TDD configuration as shown in the uplink subframes 614, and processes a subsequently generated uplink HARQ in the uplink subframes 612 and 613 so as to seamlessly maintain the uplink HARQ, even though the TDD configuration is modified.

According to an uplink HARQ retransmission method proposed in a second embodiment of the present disclosure, when a TDD configuration modification command is generated, a terminal uses a rule previously determined for a timing of uplink data channel transmission and response channel transmission, and a timing of response channel and uplink data channel retransmission, irrespective of a TDD configuration of a previous radioframe and a TDD configuration of a modified radioframe. The previously determined rule indicates a timing configuration method that secures a time of 20 msec on average between retransmissions, and includes a method of randomly linking 6 successive subframes from a subframe #3 in a radioframe and locations or indices of possible uplink HARQ retransmission that may be generated in a subsequent radioframe. Link information associated with the random link is included in a retransmission control channel.

The HARQ link method according to the second embodiment of the present disclosure corresponds to a method that uses a time t1 defined in Table 10 and a time t2 defined in Table 11.

TABLE 10

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| Any | | | | {9, 10, 11, | {8, 9, | {7, 8, | {6, 7, | {5, 6, | {4, 5, | |
| | | | | 14, 15, | 10, 13, | 9, 12, | 8, 11, | 7, 10, | 6, 9, | |
| | | | | 16, 17} | 14, 15} | 13, 14} | 12, 13} | 11, 12} | 10, 11} | |

TABLE 11

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| Any | | | | 11 | 11 | 11 | 9 | 9 | 9 | |

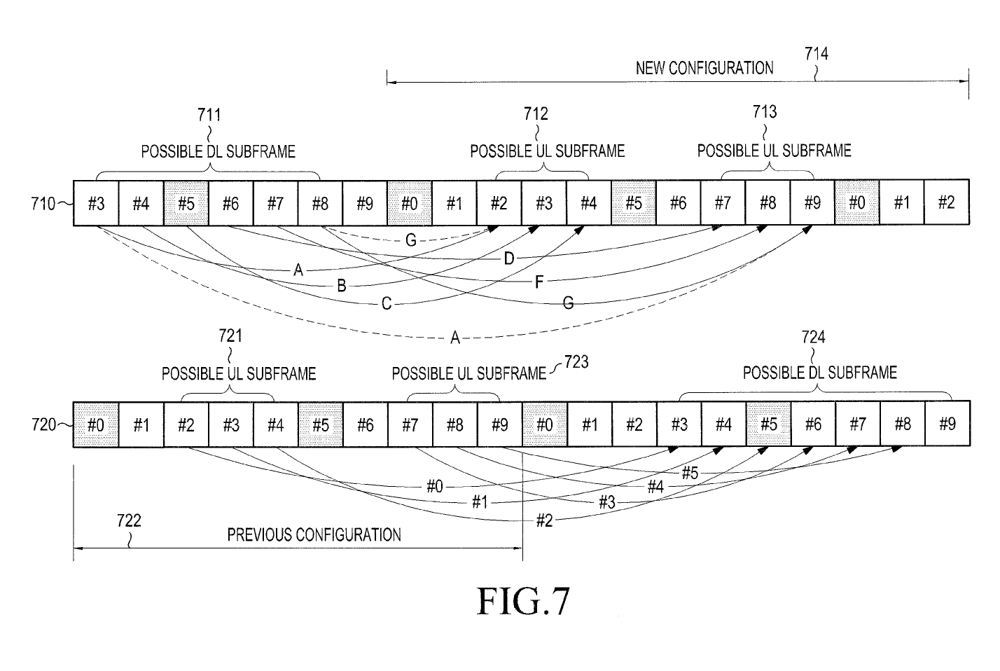

According to the second embodiment of the present disclosure, random mapping may be performed, unlike the first embodiment of the present disclosure. Accordingly, Table 10 defines all possible timings, and information associated with a timing to be used is included in a retransmission control channel. In the second embodiment of the present disclosure, a TDD configuration modification command needs to be received before at least a subframe #3, and a proposed timing needs to be applied before at least a next subframe #3 from the subframe #3, which will be described in detail with reference to FIG. 7.

FIG. 7 illustrates an uplink HARQ process according to a second embodiment of the present disclosure.

Referring to FIG. 7, the diagram 710 illustrates a timing of control channel transmission and uplink data channel transmission, and the diagram 720 illustrates a timing of uplink data channel transmission and downlink response channel transmission. In the diagram 710, a TDD configuration modification command should be received before the diagram 710, and modification is actually applied in a radioframe in the new configuration 714.

A terminal that receives the TDD configuration modification command receives a retransmission control channel or an initial transmission control channel for using an uplink HARQ after the TDD configuration modification, in one of the downlink subframes 711. The downlink subframes 711 include a total of 6 successive downlinks, and the downlinks are randomly linked with 6 possible uplink subframes that may exist in a subsequent radioframe as shown in the uplink subframes 712 and 713. Accordingly, irrespective of any TDD configuration that the TDD configuration is modified into based on the TDD configuration modification command, a control channel reception time of a possible uplink subframe is determined in a previous radioframe.

Also, by adding information associated with an uplink subframe to be used after the TDD configuration modification or information associated with a HARQ process index to a DCI of a retransmission or initial transmission control channel that is generated after the TDD configuration modification command, random mapping is performed, so that and the information is transmitted to an available subframe or a HARQ from among possible uplink subframes in the uplink subframes 712 and the uplink subframes 713. A time t1 and a time t2 for transmission of a response channel and a control channel that are generated after transmission of a data channel that begins in the uplink subframes 712, are based on a configuration defined in the configured TDD. When the TDD configuration modification command is received when an uplink data channel that is transmitted in a previous radioframe exists, a response channel transmission time with respect to the previous data channel transmission is defined as shown in the diagram 720. According to the second embodiment of the present disclosure, response channel transmission times or retransmission control channel transmission times with respect to possible uplink subframes in a previous radioframe (e.g., previous configuration 722), for example, the uplink subframes 721 and the uplink subframes 723, are sequentially mapped to 6 successive downlink subframes in a modified radioframe, for example, the downlink subframes 724. According to the configuration as described above, the terminal is capable of transmitting response channels or control channels with respect to all HARQ processes, irrespective of a number of uplinks HARQ processes that previously exist or whether retransmission exists.

A difference from the first embodiment of the present disclosure is that the second embodiment of the present disclosure transmits a response channel in 6 successive downlink subframes that may be generated after a subframe #3, so as to secure a transmission period of 20 msec on average between uplink HARQ processes when random mapping of the diagram 710 is supported. When the described HARQ processes are simultaneously used, the diagram 720 is configured so as to chronologically come before the diagram 710, and the downlink subframes 724 are identical to the downlink subframes 711. Accordingly, when a TDD configuration modification command is generated between the uplink subframes 723 and the downlink subframes 724 while a previous TDD configuration 722 is used, the terminal receives a response channel with respect to a previous uplink HARQ in the downlink subframes 724 (and the downlink subframes 711), modifies the TDD configuration as shown in the new configuration 714, and processes a subsequently generated uplink HARQ in the uplink subframes 712 and 713 by receiving a control channel in a downlink subframe of the diagram 711, so as to seamlessly maintain the uplink HARQ, even though the TDD configuration is modified.

According to a downlink HARQ retransmission method proposed in a third embodiment of the present disclosure, when a TDD configuration modification command is generated, a terminal uses a previously determined rule and timing for transmission of a downlink data channel and a response channel, irrespective of a TDD configuration of a previous radioframe and a TDD configuration of a modified radioframe. The previously determined rule indicates a retransmission method that secures a time of 20 msec between retransmissions, and includes a method of sequentially links response channel transmission and downlink subframes defined in advanced based on a number of uplink subframes included in subframes #2, #3, and #4 of the modified TDD configuration.

A downlink is distinguished based on a number of uplink subframes of the subframes #2, #3, and #4 in the modified TDD configuration, as illustrated in Table 12.

TABLE 12

| UL-DL | | | | | | | | | | |
|---|---|---|---|---|---|---|---|---|---|---|
| Config- | Subframe n | | | | | | | | | |
| uration | 0 | 1 | 2 | 3 | 4 | 5 | 6 | 7 | 8 | 9 |
| 0, 3, 6 | — | — | 13, 12, 11 | 10, 9, 8 | 8, 7, 6 | — | — | — | — | — |
| 1, 4 | — | — | 13, 12, | 9, 8, 7, | — | — | — | — | — | — |
| | | | 11, 9 | 6, 5 | | | | | | |
| 2, 5 | — | — | 13, 12, 11, | — | — | — | — | — | — | — |
| | | | 9, 8, 7, | | | | | | | |
| | | | 6, 5, 4 | | | | | | | |

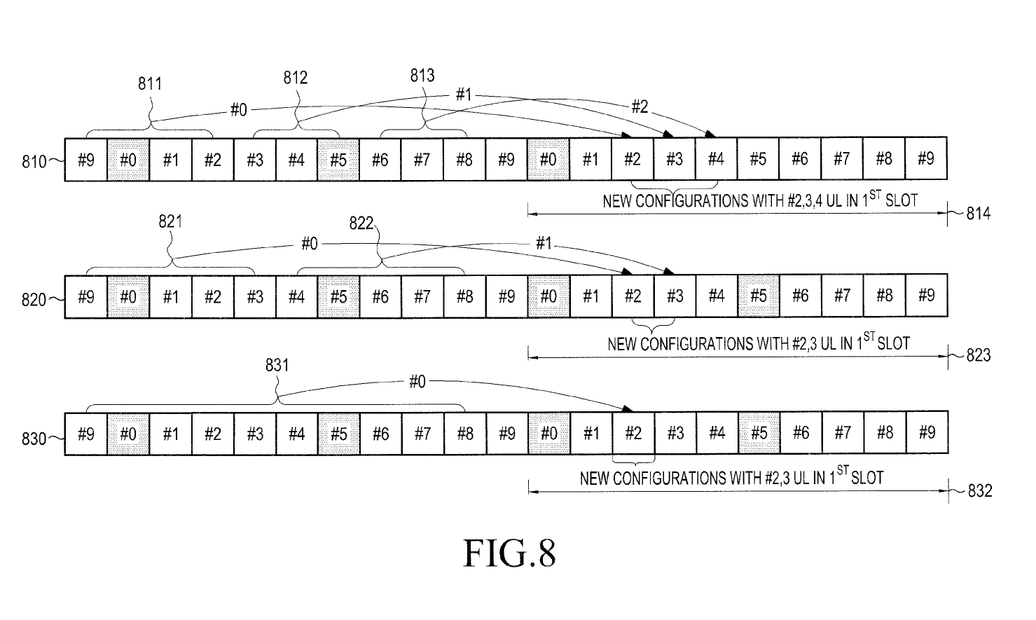

As shown in Table 12, when the number of uplink subframes is 3, (i.e., when the subframes #2, #3, and #4 are uplink subframes), the case corresponds to the TDD configurations 0, 3, and 6. When the number of uplink subframes is 2 (i.e., when the subframes #2 and #3 are uplink subframes), the case corresponds to the TDD configurations 1 and 4. When the number of uplink subframes is 1 (i.e., when the subframe #2 is an uplink subframe), the case corresponds to the TDD configurations 2 and 5. In this example, a response channel with respect to a downlink data channel generated in a previous radioframe is configured as shown in Table 12. This will be described in detail with reference to FIG. 8.

FIG. 8 illustrates a downlink HARQ process according to the third embodiment of the present disclosure.

Referring to FIG. 8, a case in which 3 uplink subframes exist corresponds to the diagram 810, a case in which 2 uplink subframes exist corresponds to the diagram 820, and a case in which 1 uplink subframe exists corresponds to the diagram 830.

In the diagram 810, when a subsequent radioframe corresponds to the TDD configurations 0, 3, and 6 as shown in the new configuration 814, downlink response channels 811, 812, and 813 may be transmitted to first three uplink subframes of the subsequent radioframe, respectively.

In the diagram 820, when a subsequent radioframe corresponds to the TDD configurations 1 and 4 as shown in the new configuration 823, downlink response channels 821 and 822 may be transmitted to first two uplink subframes of the subsequent radioframe, respectively.

In the diagram 830, when a subsequent radioframe corresponds to the TDD configurations 2 and 5 as shown in the new configuration 832, a downlink response channel 831 is transmitted to a first uplink subframe of the subsequent radioframe.

The described configuration is a method for supporting both a TDD configuration in which successive uplink subframes are provided once and a TDD configuration in which successive uplink subframes are provided twice, based on a TDD configuration. Also, the configuration is a method for supporting response channels of HARQs of all possible downlink data channels, irrespective of a TDD configuration generated in a subsequent radioframe.

The third embodiment of the present disclosure may be used together with or separately from the first embodiment and the second embodiment of the present disclosure. The third embodiment of the present disclosure may be used only when a TDD configuration modification command is generated or the third embodiment may be continuously used in a base station that operates as a dynamic TDD system without using a TDD configuration modification command during a predetermined period of time, irrespective of an uplink HARQ and a currently used TDD configuration.

According to a radioframe modification method proposed in a fourth embodiment of the present disclosure, when a TDD configuration modification command is generated for uplink or downlink HARQ retransmission, a terminal transits a TDD configuration to a TDD configuration associated with the command after two radioframes, modifies the TDD configuration into a previously configured TDD configuration after one radioframe so as to transmit response channels for a downlink HARQ and an uplink HARQ that are generated before the modification, and transmits retransmission and initial transmission control channels of a downlink HARQ and an uplink HARQ of the modified configuration. When the modification is performed based on the proposed method, all timings proposed in the present disclosure may be used as a timing of a channel.

The first, second, and third embodiments of the present disclosure may be operated based on two methods. In the first method of the two methods, a TDD configuration modification command is received in a previous radioframe, and a TDD configuration is modified into a TDD configuration associated with the command in a subsequent radioframe. In the second method of the two methods, a TDD configuration modification command is received in a previous radioframe, a radioframe for TDD configuration modification is applied for a subsequent radioframe, and a radioframe is modified that is subsequently generated into a radioframe associated with the TDD configuration modification command.

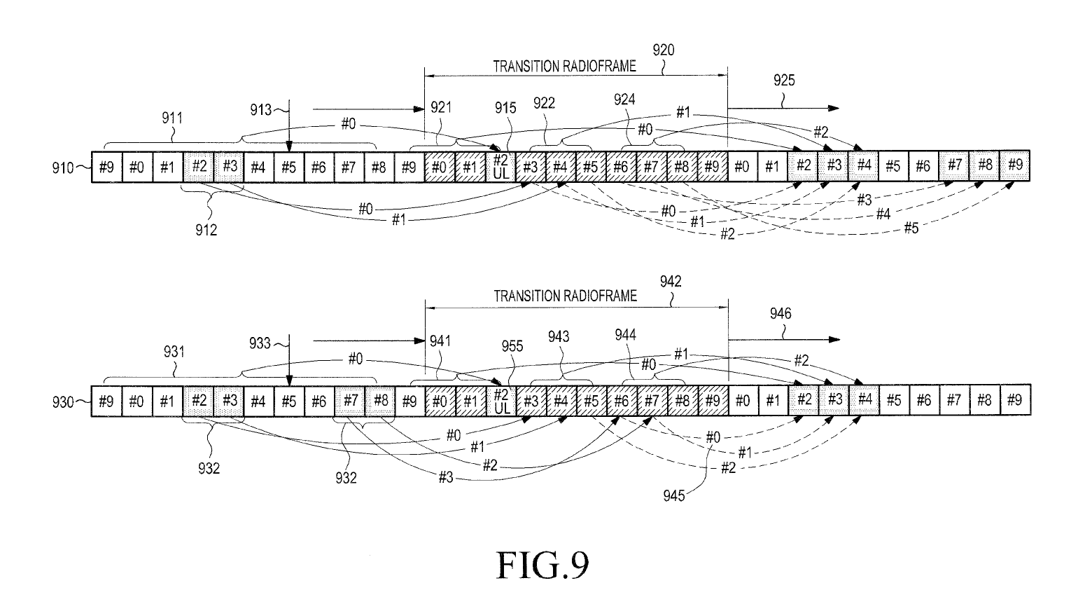

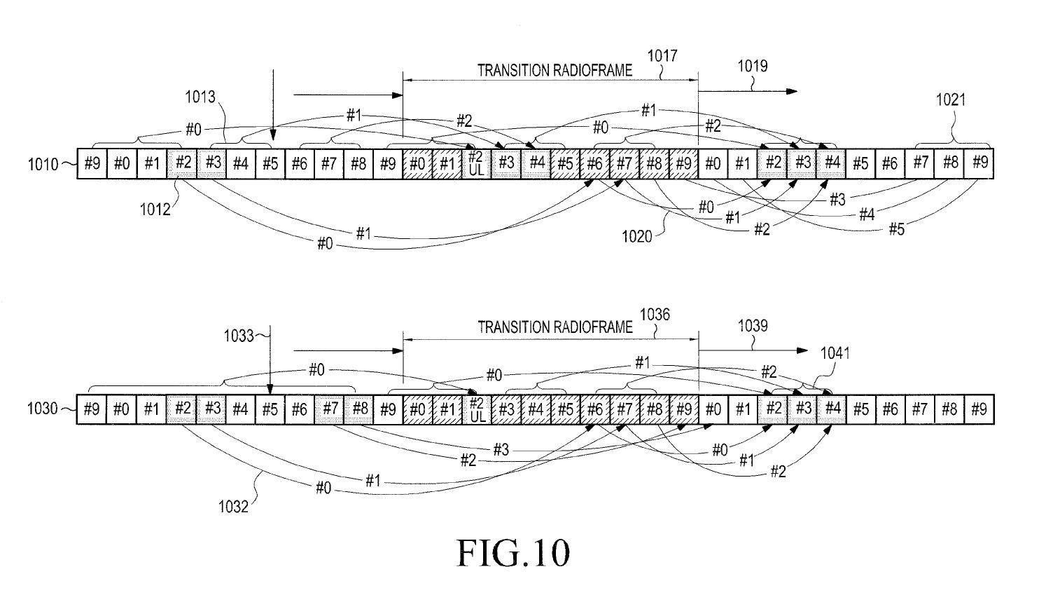

When the first method is used, an operation based on the first, second, and third embodiments of the present disclosure may be available. However, when downlink subframes are insufficient in a previous radioframe, not all HARQs of uplink subframes may be used in the radioframe that is subsequently generated. The second method is proposed to address this issue. In the second method, a transition radioframe is inserted before TDD configuration modification. A radioframe that has a maximum number of downlink subframes as shown in the TDD configuration 5 or a radioframe configuration that is determined in advance between a base station and a terminal may be used. Also, a radioframe that is indicated by a TDD configuration modification command may be used. Based on the descriptions provided above, the fourth embodiment and a fifth embodiment of the present disclosure will be described in detail with reference to FIG. 9 and FIG. 10.

FIG. 9 illustrates a HARQ process according to the fourth embodiment of the present disclosure.

Referring to FIG. 9, the diagrams 910 and 930 illustrate a method of operating the second embodiment and the third embodiment of the present disclosure using a transition radioframe. The diagram 910 illustrates a case in which a number of uplink subframes existing in a previous radioframes is smaller than a number of uplink subframes existing after modification. The diagram 930 illustrates a case in which a number of uplink subframes existing in a previous radioframe is larger than a number of uplink subframes existing after modification.

In the diagram 910, when downlink subframes 911 and uplink subframes 912 are present in a previous radioframe, when a TDD configuration modification command 913 is received, a base station inserts a transition radioframe 920, and a downlink HARQ transmits a response channel 915 as described in the third embodiment of the present disclosure.

In a case of an uplink HARQ, two HARQ processes of the uplink subframes 912 transmit response channels and control channels 922, and control channels with respect to the remaining uplink HARQs 925 generated after the transition radioframe 920 are transmitted in the channels 922 and 924. In a case of a downlink HARQ generated in the transition radioframe 920, the channels 921, 922, and 924 are respectively mapped to subframes based on a number of uplink subframes 925, so as to transmit response channels.

In a case in which downlink subframes 931 and 4 uplink subframes 932 are present in a previous radioframe, similar to the transition radioframe 920, when a TDD configuration modification command 933 is received, a base station inserts a transition radioframe 942 and thus, a downlink HARQ transmits a response channel 955 as illustrated in the third embodiment of the present disclosure. In a case of an uplink HARQ, four HARQ processes of channel 932 transmit response channels and control channels in channels 943 and 944, and random mapping 945 is performed to continuously maintain a previous HARQ with respect to an uplink HARQ 946.

FIG. 10 illustrates a HARQ process according to a fifth embodiment of the present disclosure.

Referring to FIG. 10, the diagrams 1010 and 1030 illustrate another method for implementing the first embodiment and the third embodiment of the present disclosure using a transition radioframe. A case of a downlink HARQ is similar to FIG. 9 and thus, descriptions of FIG. 10 will be provided from a perspective of an uplink HARQ.

The diagram 1010 illustrates a case in which a number of uplink subframes existing in a previous radioframe is smaller than a number of uplink subframes existing after modification, and the diagram 1030 illustrates a case in which a number of uplink subframes existing in a previous radioframe is larger than a number of uplink subframes existing after modification. In a case in which uplink subframes 1012 are present in the previous radioframe, as in the diagram 1010, when a TDD configuration modification command 1013 is received, a base station inserts a transition radioframe 1017. In a case of an uplink HARQ, two HARQ processes of the uplink subframes 1012 transmit response channels and control channels in the transition radioframe 1017 as described in the first embodiment of the present disclosure, and control channels with respect to remaining uplink HARQs generated in the channel 1019, for example, the channels 1019 and 1021, are transmitted as shown in the diagram 1020.

In a case in which 4 uplink subframes exist in a previous radioframe as shown in the diagram 1030, like the diagram 1020, when a TDD configuration modification command 1033 is received, a base station inserts a transition radioframe 1036. In a case of an uplink HARQ, four HARQ processes transmits response channels and control channels according to a mapping 1032, and sequential mapping to the transition radioframe 1036 is performed as shown in the subframes 1041 so as to continuously maintain a previous HARQ with respect to an uplink HARQ generated in the diagram 1039.

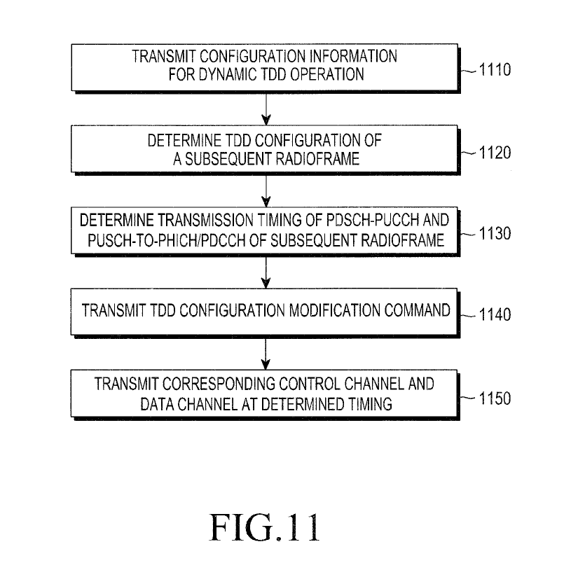

FIG. 11 is a flowchart illustrating an operation of a base station according to an embodiment of the present disclosure.

Referring to FIG. 11, the base station configures a cell to operate a dynamic TDD, and transmits configuration information for dynamic TDD operation in operation 1110. The base station determines a TDD configuration of a subsequent radioframe in operation 1120, and determines a timing of control channel transmission, data channel transmission, or retransmission control channel transmission of a downlink HARQ and an uplink HARQ based on the determined radioframe and the first through fifth embodiments of the present disclosure in operation 1130. In operation 1140, the base station transmits a TDD configuration modification command to the terminal in operation 1140, and performs transmission and reception of a corresponding control channel and data channel in operation 1150, based on the timing determined in operation 1130.

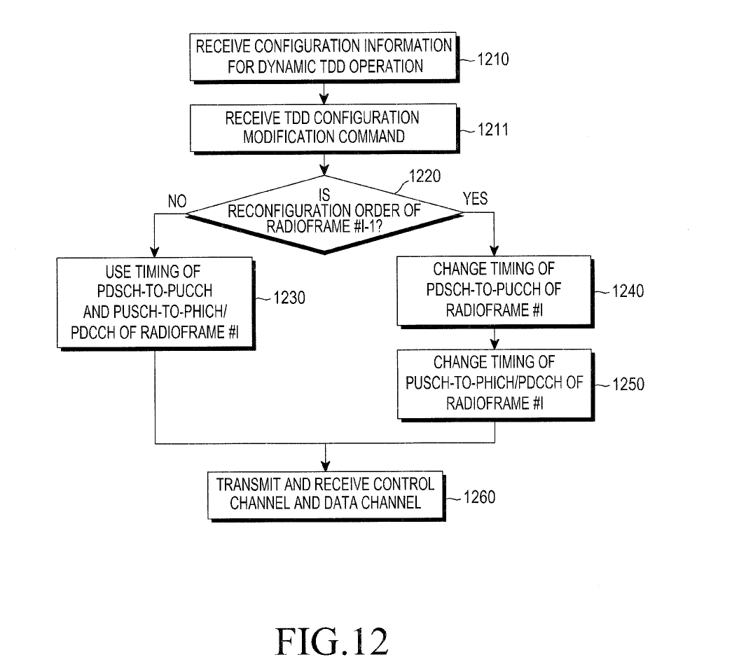

FIG. 12 is a flowchart illustrating an operation of a terminal according to an embodiment of the present disclosure.

Referring to FIG. 12, the terminal receives configuration information for operating a dynamic TDD from a base station in operation 1210, and receives a TDD configuration information modification command in operation 1211. When the terminal receives the TDD configuration information modification command in a previous radioframe in operation 1220, the terminal modifies and operates a timing associated with a downlink and uplink HARQ in operations 1240 and 1250 based on the first through fifth embodiments of the present disclosure. When the terminal does not receive the TDD configuration modification command in the previous radioframe, the terminal applies a timing based on a TDD configuration configured in a current radioframe to a downlink and uplink HARQ in operation 1230. Finally, in operation 1260, the terminal transmits and receives the control channel and the data channel.

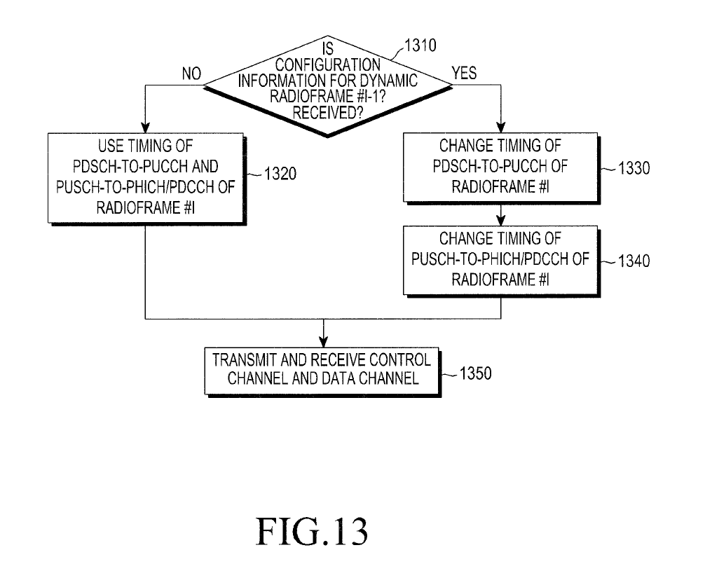

FIG. 13 is a flowchart illustrating an operation of a terminal according to an embodiment of the present disclosure.

Referring to FIG. 13, the terminal receives configuration information for dynamic TDD operation from a base station in operation 1310. Subsequently, the terminal uses a timing based on the first through fifth embodiments of the present disclosure as in operations 1330 and 1340, until the information associated with the dynamic TDD operation is updated in the base station. When the configuration information associated with the dynamic TDD operation is updated or cancelled, the terminal applies the configuration information to a previously configured downlink and uplink HARQ in operation 1320. Finally, the terminal transmits and receives the data channel and control channel in operation 1360.

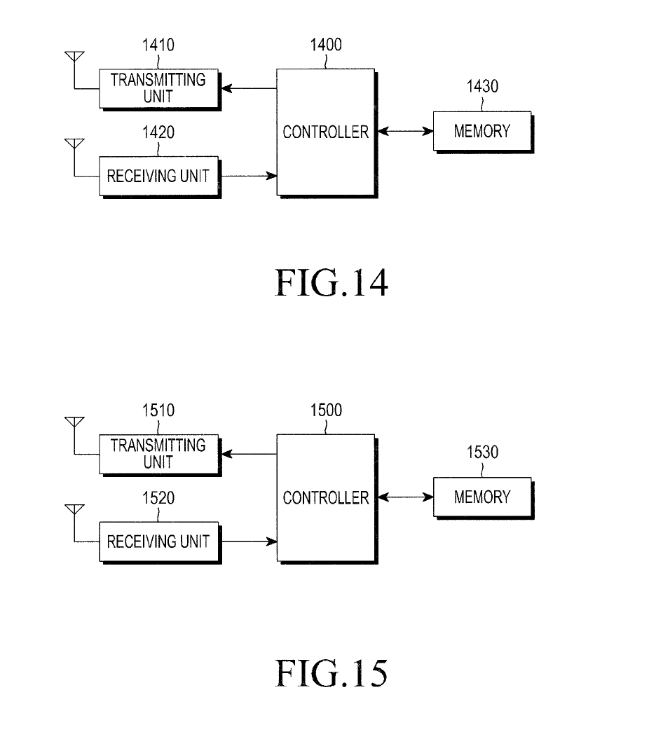

FIG. 14 is a block diagram illustrating an internal configuration of a base station according to an embodiment of the present disclosure.

Referring to FIG. 14, the base station includes a controller 1400, a transmitting unit 1410, a receiving unit 1420, and a memory 1430.

The controller 1400 controls the transmitting unit 1410, the receiving unit 1420, and the memory 1430, and controls general operations of the base station. According to an embodiment of the present disclosure, the controller 1400 calculates a timing of a downlink HARQ and an uplink HARQ based on modification of TDD configuration information, and configures a control channel therefor. Although not illustrated in FIG. 14, the base station may include a separate unit that configures a control channel.

The transmitting unit 1410 transmits the control channel to the terminal, the receiving unit 1420 receives a data channel transmitted from the terminal, and demodulates the corresponding data channel. The memory 1430 stores various data and information and the like which are generated or received in association with an operation of the base station, such as timing information calculated by the controller 1400, the data channel received from the terminal, and the like.

The controller 1400 configures a downlink data channel for downlink data channel transmission, and controls the transmitting unit 1410 to transmit the configured downlink data channel to the terminal. The controller 1400 controls the transmitting unit 1410 to transmit a TDD configuration modification command. The downlink data channel and the TDD configuration modification command may be transmitted to the terminal through a separate control channel configuration unit.

FIG. 15 is a block diagram illustrating an internal configuration of a terminal according to an embodiment of the present disclosure.

Referring to FIG. 15, the terminal includes a controller 1500, a transmitting unit 1510, a receiving unit 1520, and a memory 1530. In addition, the terminal may include other components according to a design and/or function of the terminal. For simplicity, these additional components are not shown in FIG. 15.

The controller 1500 controls the transmitting unit 1510, the receiving unit 1520, and the memory 1530, and controls general operations of the terminal According to an embodiment of the present disclosure, the controller 1500 interprets a TDD configuration modification command control channel received from a base station, and determines, based on the interpretation, transmission and reception times of a data channel for transmission and reception of the data channel, and modulation.

The receiving unit 1520 receives and demodulates a control channel. Although not illustrated in FIG. 15, the terminal may include a separate unit that configures a control channel.

The controller 1500 determines a transmission time of a data channel of a terminal and a HARQ, based on whether TDD configuration command exists of a subsequent radioframe and whether HARQ transmission exists.

The controller 1500 configures a data channel and a control channel, and controls the transmitting unit 1510 to transmit the configured data channel and control channel. Although not illustrated in FIG. 15, the terminal may include separate units that configure or transceive a data channel (a PDSCH and the like) and a control channel (a PUCCH, a PUSCH, and the like).

While the present disclosure has been shown and described with reference to various embodiments thereof, it will be understood by those skilled in the art that various changes in form and details may be made without departing from the spirit and scope of the present disclosure as defined by the appended claims and their equivalents.

What is claimed is:

1. A data transceiving method of a terminal in a mobile communication system, the data transceiving method comprising:
receiving a Time Division Duplex (TDD) configuration modification message including TDD configuration modification time information from a base station;
modifying a TDD configuration based on the TDD configuration modification time information; and
transmitting, to the base station, at least one of a data channel and a response channel by taking into consideration a transmission period between the data channel and the response channel,
wherein the transmission period is determined for mapping first subframes for transmitting at least one of a data channel and a response channel before the TDD configuration modification, onto second subframes for transmitting at least one of a data channel and a response channel after the TDD configuration modification.

2. The data transceiving method of claim 1, wherein the transmission period is determined for sequentially or randomly one-to-one mapping the first subframes onto the second subframes.

3. The data transceiving method of claim 1, wherein the transmission period is determined for mapping the first subframes onto the second subframes based on a number of the second subframes.

4. The data transceiving method of claim 1, wherein the transmission period is determined for mapping the first subframes onto the second subframes by generating an additional subframe between the first subframes and the second subframes based on a result of comparing a number of the first subframes and a number of the second subframes.

5. The data transceiving method of claim 1, further comprising:
receiving a control channel from the base station in third subframes which correspond to previous subframes of the first subframes,
wherein the first subframes and the third subframes are randomly mapped one-to-one based on the transmission period defined according to the following table: 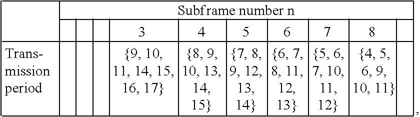
and
wherein the transmission period is determined for each subframe according to the following table:

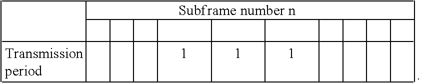

6. A data transceiving method of a base station in a mobile communication system, the data transceiving method comprising:
transmitting, to a terminal, a Time Division Duplex (TDD) configuration modification message including TDD configuration modification time information;
modifying a TDD configuration based on the TDD configuration modification time information; and
receiving, from the terminal, at least one of a data channel and a response channel by taking into consideration a reception period between the data channel and the response channel,
wherein the reception period is a period determined for mapping first subframes for receiving at least one of a data channel and a response channel before the TDD configuration modification onto second subframes for receiving at least one of a data channel and a respond channel after the TDD configuration modification.

7. The data transceiving method of claim 6, wherein the reception period is determined for sequentially or randomly mapping the first subframes onto the second subframes one-to-one.

8. The data transceiving method of claim 6, wherein the reception period is determined for mapping the first subframes onto the second subframes based on a number of the second subframes.

9. The data transceiving method of claim 6, wherein the reception period is determined for mapping the first subframes onto the second subframes by generating an additional subframe between the first subframes and the second subframes based on a result of comparing a number of first subframes and a number of second subframes.

10. The data transceiving method of claim 6, further comprising:
transmitting a control channel to the terminal in third subframes that correspond to previous subframes of the first subframes,
wherein the first subframes and the second subframes are randomly mapped one-to-one based on a transmission period according to the following table: 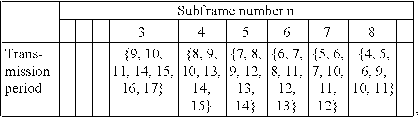
and
wherein the reception period is determined for each subframe according to the following table:

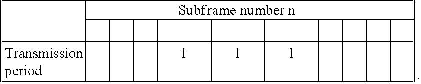

11. A terminal in a mobile communication system, the terminal comprising:
a receiving unit configured to receive, from a base station, a Time Division Duplex (TDD) configuration modification message including TDD configuration modification time information;
a controller configured to modify a TDD configuration based on the TDD configuration modification time information; and
a transmitting unit configured to transmit, to the base station, at least one of a data channel and a response channel by taking into consideration a transmission period between the data channel and the response channel,
wherein the transmission period is a period determined for mapping first subframes for transmitting one of a data channel and a response channel before TDD configuration modification onto second subframes for transmitting one of a data channel and a response channel after the TDD configuration modification.

12. The terminal of claim 11, wherein the transmission period is a period determined for sequentially or normally mapping the first subframes onto the second subframes one-to-one.

13. The terminal of claim 11, wherein the transmission period is determined for mapping the first subframes onto the second subframes based on a number of the second subframes.

14. The terminal of claim 11, wherein the transmission period is a period determined for mapping the first subframes onto the second subframes by generating an additional subframe between the first subframes and the second subframes based on a result of comparing a number of the first subframes and a number of second subframes.

15. The terminal of claim 11, wherein the receiving unit receives a control channel from the base station in third subframes that correspond to previous subframes of the first subframes, and the first subframes and the second subframes are randomly mapped one-to-one based on a transmission period defined in the following table: 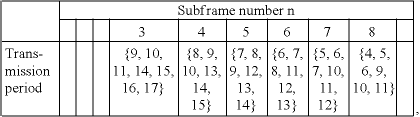
and
wherein the transmission period is determined for each subframe according to the following table:

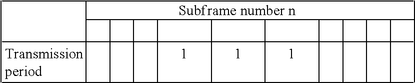

16. A base station in a mobile communication system, the base station comprising:
a transmitting unit configured to transmit, to a terminal, a Time Division Duplex (TDD) configuration modification message including TDD configuration modification time information;
a controller configured to modify a TDD configuration based on the TDD configuration modification time information; and
a receiving unit configured to receive, from the terminal, at least one of a data channel and a response channel by taking into consideration a reception period between the data channel and the response channel,
wherein the reception period is a period determined for mapping first subframes for receiving at least one of a data channel and a response channel before TDD configuration modification onto second subframes for receiving at least one of a data channel and a response channel after the TDD configuration modification.

17. The base station of claim 16, wherein the reception period is a period determined for sequentially or randomly mapping the first subframes onto the second subframes one-to-one.

18. The base station of claim 16, wherein the reception period is a period determined for mapping the first subframes onto the second subframes based on a number of the second subframes.

19. The base station of claim 16, wherein the reception period is a period determined for mapping the first subframe onto the second subframe by generating an additional subframe between the first subframes and the second subframes based on a result of comparing a number of the first subframes and a number of the second subframes.

20. The base station of claim 16, wherein the transmitting unit transmits a control channel to the terminal in third subframes that correspond to previous subframes of the first subframes, and the first subframes and the second subframes are randomly mapped one-to-one based on a transmission period according to the following table: 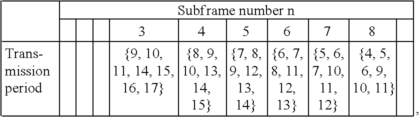
and
wherein the reception period is determined for each subframe according to the following table: [chemical structure]
